(19) United States
(12) Patent Application Publication
(10) Pub. No.: US 2014/0062884 A1
(43) Pub. Date: Mar. 6, 2014

(54) INPUT DEVICES

(71) Applicant: GE AVIATION SYSTEMS LIMITED, Cheltenham (GB)

(72) Inventors: John Alun Davies, Gloucester (GB); Luke Patrick Bolton, Cheltenham (GB); Stephane Collet-Vander Eecken, Cheltenham (GB)

(73) Assignee: GE AVIATION SYSTEMS LIMITED, Cheltenham (GB)

(21) Appl. No.: 13/719,978

(22) Filed: Dec. 19, 2012

(30) Foreign Application Priority Data
Aug. 28, 2012 (GB) 12152161

(51) Int. Cl. G06F 3/0354

(52) U.S. Cl. CPC G06F 3/0354
USPC 345/167

(57) ABSTRACT

Input devices for a computer-based system include a touch screen comprising a dynamic input portion on which context-sensitive user inputs may be displayed, a cursor control comprising a palm rest and a track ball. The palm rest may be located relative to the track ball and the dynamic input portion of the touch screen for ease of use by the user.

### CROSS-REFERENCE TO RELATED APPLICATIONS

This application claims priority under 35 U.S.C. §119 to British Patent Application No. 12152161, filed Aug. 28, 2012, the disclosure of which is incorporated herein by reference in its entirety.

### BACKGROUND OF THE INVENTION

Contemporary aircraft cockpits utilize a combination of cursor control devices including trackballs or touchpads, rotary encoders, selection buttons, and keyboards to allow the flight crew to interact with various computer-based systems of the aircraft. Touch screen controls are more frequently being used and emerging flight deck applications require an increased level of interaction with the on-screen information. This is partly due to the added complexity of the systems and partly due to the expectations for modern computer-based human-machine interface (HMI). Such touch screens and variety of interactive devices, if not implemented in an optimized fashion, can increase the workload of the flight crew and can be cumbersome to work with.

### BRIEF DESCRIPTION OF THE INVENTION

In one embodiment, the invention relates to an input device for a computer-based system having a touch screen comprising a dynamic input portion on which context-sensitive user inputs may be displayed and a cursor control comprising a palm rest and a track ball. The palm rest is located relative to the track ball and the dynamic input portion such that a user's palm may rest on the palm rest while fingers on a hand of the resting palm reach the track ball and the dynamic input portion.

### BRIEF DESCRIPTION OF THE DRAWINGS

In the drawings:

FIG. 1 is a perspective view of a portion of an aircraft cockpit with a flight deck having multiple input devices according to an embodiment of the invention.

FIG. 2 is an enlarged view of one of the input devices in FIG. 1.

FIG. 3 is schematic view of a user using the input device illustrated in FIG. 2.

FIG. 4 is a second schematic view of a user using the input device illustrated in FIG. 2.

### DESCRIPTION OF EMBODIMENTS OF THE INVENTION

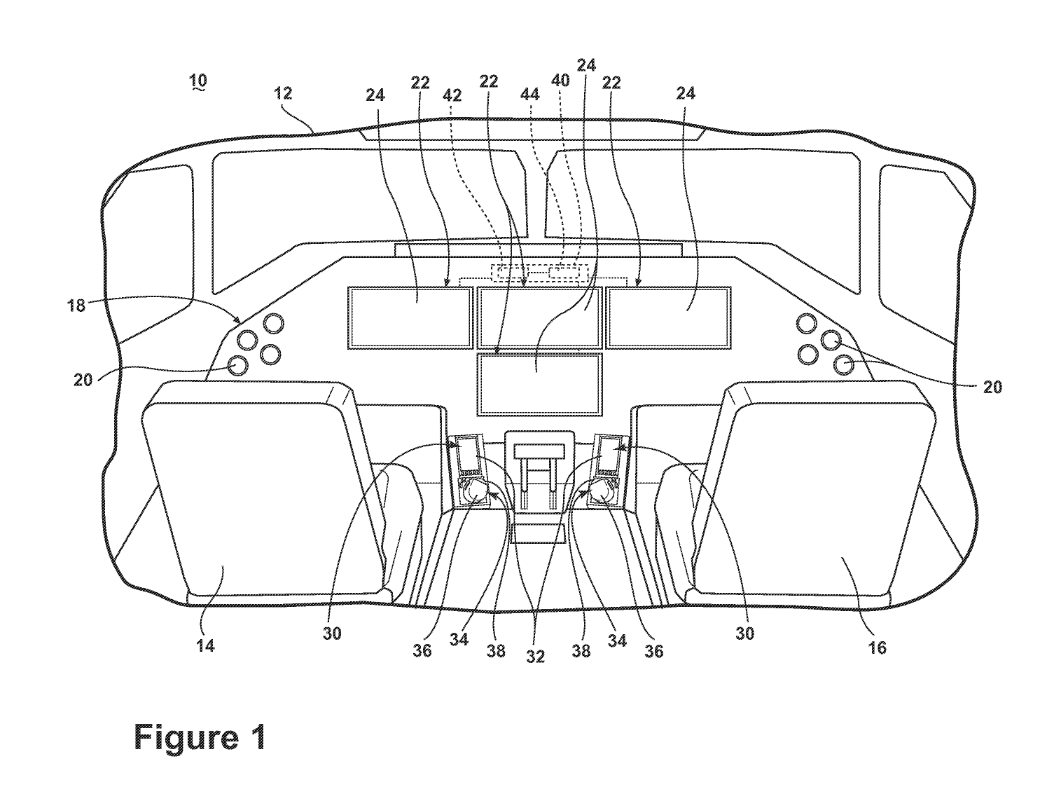

FIG. 1 illustrates a portion of an aircraft 10 having a cockpit 12 according to one embodiment of the invention. While a commercial aircraft has been illustrated, it is contemplated that embodiments of the invention may be used in any type of aircraft, for example, without limitation, fixed-wing, rotating-wing, rocket, personal aircraft, and military aircraft. A first user (e.g., a pilot) may be present in a seat 14 at the left side of the cockpit 12 and another user (e.g., a co-pilot) may be present at the right side of the cockpit 12 in a seat 16. A flight deck 18 having various instruments 20 and multiple multifunction flight displays 22 may be located in front of the pilot and co-pilot and may provide the flight crew with information to aid in flying the aircraft 10. The flight displays 22 may include either primary flight displays or multi-function displays and may display a wide range of aircraft, flight, navigation, and other information used in the operation and control of the aircraft 10.

The flight displays 22 have been illustrated as being in a spaced, side-by-side arrangement with each other. The flight displays 22 may be laid out in any manner including having fewer or more displays. Further, the flight displays 22 need not be coplanar and need not be the same size. A touch screen display or touch screen surface 24 may be included in the flight display 22 and may be used by one or more flight crew members, including the pilot and co-pilot, to interact with the systems of the aircraft 10. Such touch screen surface 24 may take any suitable form including that of a liquid crystal display (LCD) and may use various physical or electrical attributes to sense inputs from the flight crew. While all of the flight displays 22 have been illustrated as including touch screen surfaces 24, it is contemplated that only some of the flight displays 22 may include such touch screen surfaces 24.

An input device 30 is included near each seat 14 and 16 for use by the users in seats 14 and 16, respectively. The input device may be used in conjunction with the computer-based system in the aircraft and allows the flight crew members to interact with the systems of the aircraft 10. A touch screen 32 and a cursor control 34 including a wrist rest or palm rest 36 and a track ball 38 may be included in each input device 30. The palm rest 36 may aid in orientating the crew member's hand when operating the input device 30. As illustrated, for exemplary purposes only, the input device 30 near the seat 14 is a right-handed input device and the input device near the seat 16 is a left-handed input device. It will be understood that should the user in the seat 16 be right-handed the input device 30 may be moved to the other side of the seat 16. The cursor control 34 includes a track ball 38, which may accept input from a user and convert that input to a graphical position on any of the multiple flight displays 22 or the touch screen 32.

A controller 40 may be operably coupled to components of the aircraft 10 including the flight displays 22, touch screen surface 24, and input device 30. The controller 40 may include memory 42, the memory may include random access memory (RAM), read-only memory (ROM), flash memory, or one or more different types of portable electronic memory, such as discs, DVDs, CD-ROMs, etc., or any suitable combination of these types of memory. The controller 40 may include a processor 44, which may be running any suitable programs to implement a graphical user interface (GUI) and operating system. These programs typically include a device driver that allows the user to perform functions on the touch screen surface 24 and the touch screen 32 such as selecting options, inputting commands and other data, selecting and opening files, and moving icons through the touch screen surface 24 and the touch screen 32. The controller 40 may be a portion of a Flight Management System (FMS) or may be operably coupled to the FMS. The controller 40 may also be connected with other controllers of the aircraft 10.

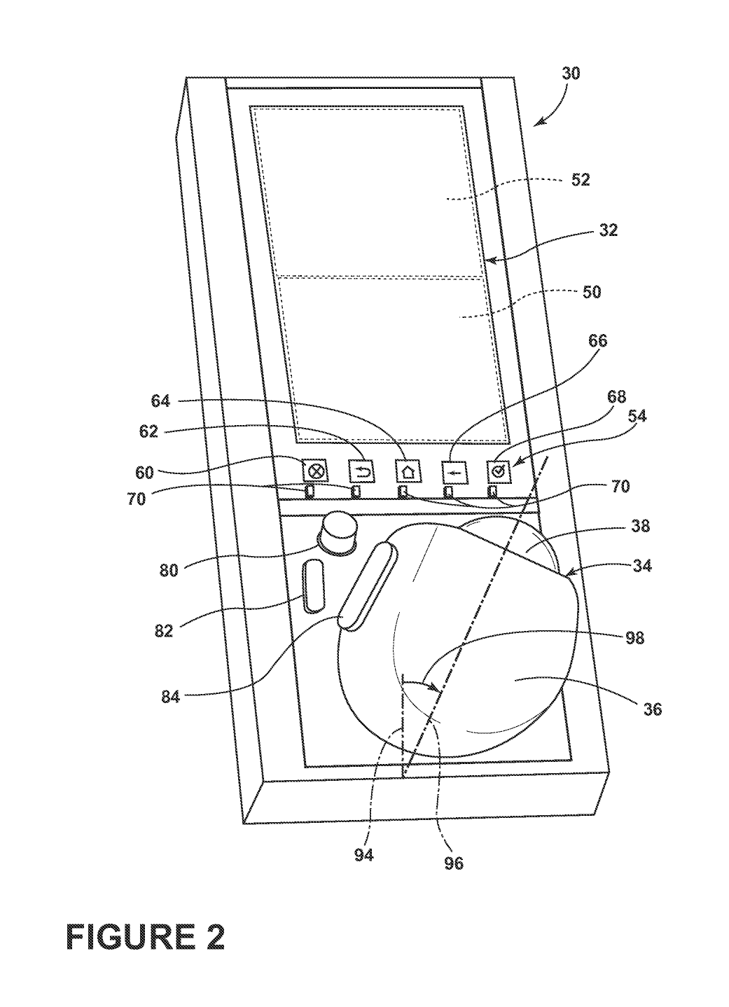

FIG. 2 is an enlarged view of one of the input devices 30 according to an embodiment of the invention. The illustrated input device 30 is a right-handed input device 30 and will be described as such. As may more clearly be seen, the touch screen 32 includes a dynamic input portion 50 on which context-sensitive user inputs may be displayed. The dynamic input portion 50 may include a display panel behind the touch screen 32 that displays different information depending on the context of operation.

The touch screen 32 also may include a message portion 52. The message portion 52 may be distally beyond the dynamic input portion 50 relative to the palm rest 36 and the size of this additional message portion 52 may vary greatly. The message portion 52 of the input device 30 may be touch-capable, but it is contemplated that no touch interactions will be in this area as this area may not be comfortably reached and operated when the user's palm is resting on the palm rest 36. Instead the message portion 52 may be used as an additional information display for the flight crew member. In some implementations, the message portion 52 may not be necessary and/or may be moved to a different location, such as beside the dynamic input portion 50, or even below the palm rest 36.

The input device 30 may include any number of suitable additional input components. For example, a fixed input portion 54 may be included in the input device 30 and may have predetermined user inputs. In the illustrated example, the fixed input portion 54 is located between the dynamic input portion 50 and the track ball 38. In this manner, the fixed input portion 54 may be thought of as being located distally of the track ball 38. It is contemplated that dynamic input portion 50, the message portion 52, and the fixed input portion 54 may all be part of the touch screen 32. Alternatively, portions may not be part of the touch screen 32 including that the message portion 52 may not be part of the touch screen 32 and that the fixed input portion 54 may include separate mechanical inputs such as buttons or “hard” keys.

The fixed input portion 54 may have any suitable number and type of predetermined user inputs and has been illustrated as including a decline key 60, an undo key 62, a home key 64, a back key 66, and an accept key 68. The fixed input portion 54 may be permanently visible when the input device 30 is powered and will always have the same function as identified by their icons. The keys 60-68 may be of a sufficient size to be operated reliably in a vibrating aircraft environment; for example, the keys 60-68 may be sixteen millimeters squared. Features with a physical profile such as grooves, recesses, bumps, protrusions, and the like may assist the user with tactile positioning relative to the keys. For example, raised features 70 may be included on the input device 30, directly underneath the fixed input portion 54 and aligned with each of the keys 60-68. Such raised features may allow a user to maintain alignment of their hand with the fixed input portion 54 without visual focus as the keys 60-68 themselves may have no physical profile if they are included in the touch screen 32. Such raised features 70 may promote so-called “eyes-out” or “head-up” operation by the crew, increasing crew situational awareness.

By way of further example, a selector wheel 80 may also be included in the input device 30. The selector wheel 80 has been illustrated on a thumb side of the track ball 38 in the illustrated right-handed input device 30. The selector wheel 80 may include any suitable selector wheel mechanism including a rotary encoder. Further still, one or more selector keys may be included in the input device 30. More specifically, a selector key 82 has been illustrated as being on the thumb-side of the cursor control 34. Further, a selector key 84 has been illustrated as being located on the palm rest 36 on a thumb-side of the track ball 38.

The touch screen 32 may have a first body axis 94 and the palm rest 36 may have a second body axis 96, which is oriented at an angle 98 relative to the first body axis 94. In the illustrated embodiment and by way of non-limiting example only, the angle 98 has been illustrated as being about 15 degrees. Trials have indicated that rotational offset of the cursor control 34 and thus the second body axis 96 contributes to comfort and ergonomic satisfaction of the user. It is contemplated that in an alternative embodiment, a user may be able to configure the cursor control 34 to a preferred angle although this may increase the wear on the input device 30 and decrease its lifetime.

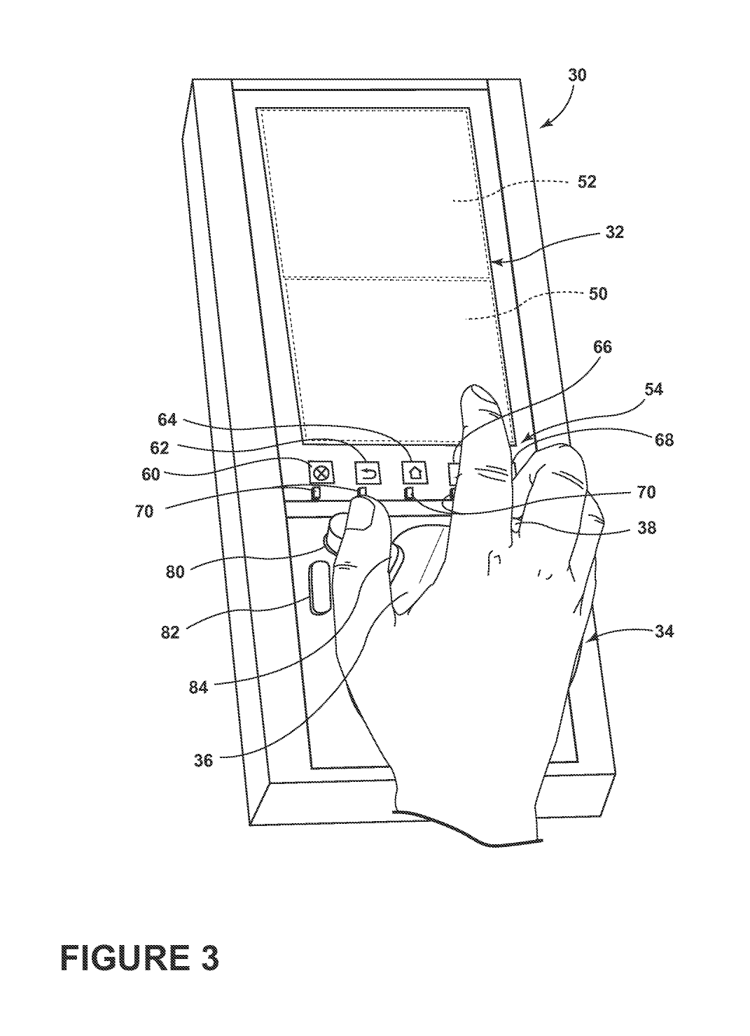

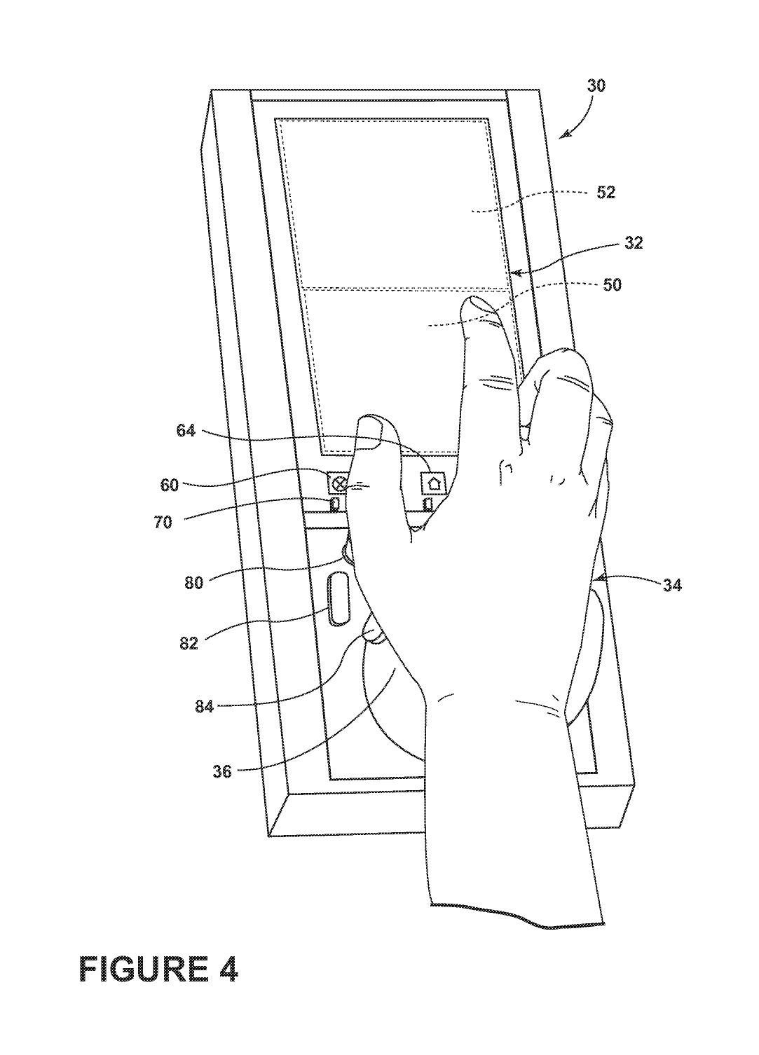

Regardless of the angle, the palm rest 36 may be located relative to the track ball 38 and the dynamic input portion 50 such that a user's palm may rest on the palm rest 36 while fingers on a hand of the resting palm reach the track ball 38 and the dynamic input portion 50 as shown in FIG. 3. It is also contemplated that the palm rest 36 may be located relative to the track ball 38 and the dynamic input portion 50 such that a user's wrist may rest on the palm rest 36 while fingers on a hand of the resting wrist reach the dynamic input portion 50 as shown in FIG. 4. For example, at least a first portion of the palm rest 36 may be within 21.1 millimeters from a first portion of the dynamic input portion 50. By way of further example, at least a second portion of the palm rest 36 may be within 16.5 millimeters from a second portion of the dynamic input portion 50. In the illustrated example, the first portion and second portion of the palm rest 36 are a center point of the palm rest 36. Further, at least one of the first portion of the dynamic input portion 50 is a distally greatest point of the dynamic input portion 50 from the center point of the palm rest 36, and the second portion is a distally least point of the dynamic input portion 50 from the center point of the palm rest 36. Alternatively, the center point of the palm rest 36 may be less than 21.1 millimeters from a distally greatest point of the dynamic input portion 50, and greater than 16.5 millimeters from a distally closest point of the dynamic input portion 50.

Further, when additional inputs are included in the input device 30, such as the fixed input portion 54, selector wheel 80, and/or selector keys 82 and/or 84, the palm rest 36 may be located relative to the track ball 38 and the dynamic input portion 50 such that a user's palm may rest on the palm rest 36 while at least one of the fingers on the hand of the resting palm may reach the track ball 38, the dynamic input portion 50, the fixed input portion 54, the selector wheel 80, the selector key 82, and the selector key 84. In the described embodiments it will be understood that a thumb for purposes of this description is considered a finger and some of the inputs may be operated by the thumb of the user while the user's palm rests on the palm rest 36. Thus, the use of the term finger includes the thumb, unless expressly stated otherwise.

The dimensions of the input device 30 may be predetermined in any way but it is contemplated that the dimensions may be selected based on a subset of human hand sizes. Such subsets may be based on geographic origin and average hand sizes corresponding thereto, see for example the disclosure in the Handbook of Normal Physical Measurements. (Hall, Judith G., Ursula G. Froster-Iskenius, Judith E. Allanson. Handbook of Normal Physical Measurements, Volume 177. Oxford University Press, 1989.). Alternatively, the dimensions of the input device 30 may be based on a pilot profile, which may include standard hand measurements for that specific user. Further, the palm rest 36 may be designed to provide comfortable operation for a range of hand sizes corresponding to the anthropometric range of hand sizes for aircraft crew.

During operation, a user may use any of the several ways of interaction including the track ball 38, the dynamic input portion 50, the fixed input portion 54, the selector wheel 80, the selector key 82, and the selector key 84. The user may work predominantly with their hand resting on the palm rest 36 and from this baseline hand position the trackball 38 can be operated with any combination of the user's four fingers with the thumb resting to the side. The fixed input portion 54 may be reached with the palm still supported on the palm rest 36 and without interfering with the trackball 38. By extending the fingers and in some cases lifting the hand from the palm rest 36, the dynamic input portion 50 can be reached and operated. For a median hand size, the majority of functions on the touch screen 32 are reachable with the palm rest 36 still providing some support. The selector wheel 80 may be operated with thumb and forefinger, involving a slight rotation of the hand. This can also be achieved with the palm resting on the palm rest 36 and without interfering with either of the selector keys 82 and 84. The selector key 82 may be in a position where it can be operated by the users thumb or forefinger depending on the user's preference. The selector key 84 may be operated by the users thumb with the palm still resting on the palm rest 36.

When the user touches the input device 30 various input touches may be recognized by the controller 40 and portions of the aircraft 10 may be operated accordingly. The input device 30 allows flight crew members to interact with the information they see on the flight displays 22 and hear through the flight deck audio system. It also allows the crew to configure the flight deck environment, for example, brightness of the displays or volume of the flight deck audio.

The above described embodiments provide for a variety of benefits including providing a single point of interaction which alleviates workload. Further, the embodiments described above have increased ergonomic comfort for the crew member who can interact with multiple systems without reaching around the flight deck. Further, the above described embodiments contribute to an overall improvement in situational awareness for the crew. Further, rather than present the crew with a set of disparate controls for each application or subsystem, the embodiments described above provide a compact solution which, once learned, can be operated rapidly, intuitively and with minimized opportunities for errors. The close proximity of the controls and the dynamic input portion of the touch screen mean that all modes of interaction can be provided within a single hand's reach. Further, the above described embodiments allow for enhanced comfort of the user when using the device for extended periods. Further, the above described embodiments have a compact design which is beneficial as space is at a premium within the flight deck. Further, portions of the touch screen including the fixed input portions provide a technical advantage over conventional buttons in that they have no moving parts and so should not be susceptible to wear or sticking.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An input device for a computer-based system, comprising:
a touch screen comprising a dynamic input portion on which context-sensitive user inputs may be displayed; and
a cursor control comprising a palm rest and a track ball;
wherein the palm rest is located relative to the track ball and the dynamic input portion and at least one of a user's palm may rest on the palm rest while fingers on a hand of the resting palm reach the track ball and the dynamic input portion and a user's wrist may rest on the palm rest while fingers on a hand of the resting wrist reach the dynamic input portion.

2. The input device of claim 1 wherein at least a first portion of the palm rest is within 21.1 millimeters from a first portion of the dynamic input portion.

3. The input device of claim 2 wherein at least a second portion of the palm rest is within 16.5 millimeters from a second portion of the dynamic input portion.

4. The input device of claim 3 wherein the first portion and the second portion of the palm rest are a center point of the palm rest.

5. The input device of claim 4 wherein at least one of the first portion of the dynamic input portion is a distally greatest point of the dynamic input portion from the center point, and the second portion is a distally least point of the dynamic input portion from the center point.

6. The input device of claim 4 wherein the first portion of the dynamic input portion is a distally greatest point of the dynamic input portion from the center point, and the second portion is a distally least point of the dynamic input portion from the center point.

7. The input device of claim 1 wherein the touch screen has a first body axis, and the palm rest has a second body axis, which is oriented at an angle relative to the first body axis.

8. The input device of claim 7 wherein the angle is 15 degrees.

9. The input device of claim 1, further comprising a fixed input portion having predetermined user inputs.

10. The input device of claim 9 wherein the fixed input portion is located between the dynamic input portion and the track ball.

11. The input device of claim 10 wherein the fixed input portion comprises at least one of the following keys: decline, undo, home, back, and accept key.

12. The input device of claim 10 wherein the fixed input portion comprises part of the touch screen.

13. The input device of claim 1, further comprising a selector wheel on a thumb side of the track ball.

14. The input device of claim 13 wherein the selector wheel comprises a rotary encoder.

15. The input device of claim 1, further comprising at least one selector key.

16. The input device of claim 1 wherein the touch screen further comprises a message portion.

17. The input device of claim 16 wherein the message portion is distally beyond the dynamic input portion relative to the palm rest.

18. An input device for a computer-based system, comprising:
a touch screen comprising a dynamic input portion on which context-sensitive user inputs may be displayed;
a cursor control comprising a palm rest and a track ball;
a fixed input portion having predetermined user inputs located distally of the track ball; and
a selector wheel on a thumb side of the track ball;
wherein the palm rest is located relative to the track ball and the dynamic input portion such that a user's palm may rest on the palm rest while at least one of the fingers on the hand of the resting palm may reach the track ball, the dynamic input portion, and the selector wheel.

19. The input device of claim 18, further comprising a selector key located on at least one of the palm rest and a thumb-side of the track ball.

20. The input device of claim 19 wherein the touch screen has a first body axis, and the palm rest has a second body axis, which is oriented at an angle relative to the first body axis.

21. The input device of claim 20 wherein the angle is 15 degrees.

22. The input device of claim 20 wherein a center point of the palm rest is less than 21.1 millimeters from a distally greatest point of the dynamic input portion, and greater than 16.5 millimeters from a distally closest point of the dynamic input portion.

23. The input device of claim 22, further comprising a message portion distally of the dynamic input portion.

24. The input device of claim 23 wherein the fixed input portion and the message portion comprise part of the touch screen.
